(19) United States
(12) Patent Application Publication
(10) Pub. No.: US 2025/0068101 A1
(43) Pub. Date: Feb. 27, 2025

(54) TONER CARTRIDGE AND IMAGE FORMING APPARATUS

(71) Applicant: FUJIFILM Business Innovation Corp., Tokyo (JP)

(72) Inventors: Yosuke NINOMIYA, Yokohama-shi (JP); Satoru ISHII, Yokohama-shi (JP)

(73) Assignee: FUJIFILM Business Innovation Corp., Tokyo (JP)

(21) Appl. No.: 18/421,561

(22) Filed: Jan. 24, 2024

(30) Foreign Application Priority Data
Aug. 21, 2023 (JP) 2023-133999

(51) Int. Cl. G03G 15/08

(52) U.S. Cl. CPC G03G 15/0891; G03G 15/0872; G03G 15/0877; G03G 2215/0668

(57) ABSTRACT

A toner cartridge includes: an opening part located on a downstream side in a toner transport direction; and a transport part configured to transport toner toward the opening part as the transport part rotates. The transport part has a spiral ridge formed on an inner surface thereof. The spiral ridge has an upstream facing slope facing an upstream side in the toner transport direction. The upstream facing slope becomes less steep toward the upstream side in the toner transport direction.

### CROSS-REFERENCE TO RELATED APPLICATIONS

This application is based on and claims priority under 35 USC 119 from Japanese Patent Application No. 2023-133999 filed Aug. 21, 2023.

### BACKGROUND

### (i) Technical Field

The present disclosure relates to a toner cartridge and an image forming apparatus.

### (ii) Related Art

Japanese Unexamined Patent Application Publication No. 9-197783 discloses a technique for enabling stable toner supply regardless of the amount of toner in a toner bottle. Specifically, the toner bottle has a ridge on the inner wall thereof, and the pitch of the ridge gradually decreases toward the end opposite to a toner discharge port.

Japanese Unexamined Patent Application Publication No. 11-109740 discloses a technique for providing a toner cartridge that constantly and stably supplies toner by preventing deformation thereof due to its own weight and deterioration of toner due to heat. Specifically, a certain portion of a toner bottle is thickened compared to the remainder of the toner bottle, so that the heat of a fixing device is less likely to be transmitted to the toner bottle.

Japanese Unexamined Patent Application Publication No. 2011-221452 discloses a technique for preventing toner from being compacted near a toner discharge port in a toner transport path and preventing a locking phenomenon. Specifically, a spiral blade of a toner transport device has such a cross-sectional shape (a mountain shape or trapezoidal shape) that the thickness thereof gradually decreases from the inner end on a rotary shaft side toward the outer end. The spiral blade has a thick portion at a position facing the toner discharge port. At the thick portion, the thickness of the spiral blade gradually increases toward the downstream side of the toner transport path.

### SUMMARY

In one technique, a toner cartridge has a spiral ridge on the inner surface thereof to transport the toner as the toner cartridge rotates. Because the toner accumulates on the spiral ridge, the toner is sometimes removed by supplying air from an opening part located on the downstream side in the toner transport direction.

However, when toner has accumulated on an upstream-facing slope, which is a slope facing the side opposite to the opening part, of the spiral ridge, the toner may remain on the slope because the toner located farther away from the opening part is more difficult to remove.

Aspects of non-limiting embodiments of the present disclosure relate to, in a toner cartridge having an opening part and a spiral ridge formed on the inner surface thereof, reducing residual toner on an upstream-facing slope, which is a slope facing the side opposite to the opening part, of the spiral ridge.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

A toner cartridge includes: an opening part located on a downstream side in a toner transport direction; and a transport part configured to transport toner toward the opening part as the transport part rotates, the transport part has a spiral ridge formed on an inner surface thereof, the spiral ridge has an upstream facing slope facing an upstream side in the toner transport direction, the upstream facing slope becomes less steep toward the upstream side in the toner transport direction.

### BRIEF DESCRIPTION OF THE DRAWINGS

Exemplary embodiments of the present disclosure will be described in detail based on the following figures, wherein:

FIG. 1 illustrates an image forming apparatus according to exemplary embodiments of the present disclosure;

FIG. 2 is a perspective view illustrating the overall structure of a toner cartridge, as viewed from a rear side;

FIG. 3 is a cross-sectional view of an opening part of the toner cartridge, taken along line III-III in FIG. 2;

FIGS. 4A and 4B illustrate the structure of a transport part;

FIG. 5 illustrates the structure of a spiral ridge according to a first exemplary embodiment;

FIG. 6 illustrates a second exemplary embodiment;

FIG. 7 illustrates a third exemplary embodiment;

FIG. 8 illustrates a fourth exemplary embodiment;

FIG. 9 illustrates a fifth exemplary embodiment;

FIG. 10 illustrates a sixth exemplary embodiment;

FIG. 11 illustrates a seventh exemplary embodiment;

FIG. 12 illustrates an eighth exemplary embodiment;

FIG. 13 illustrates a recycling process according to the exemplary embodiments of the present disclosure; and

FIG. 14 illustrates a toner cartridge of the related art.

### DETAILED DESCRIPTION

### Related Art

First, a toner cartridge of the related art will be described. The exemplary embodiments of the present disclosure are not applied to the toner cartridge of the related art.

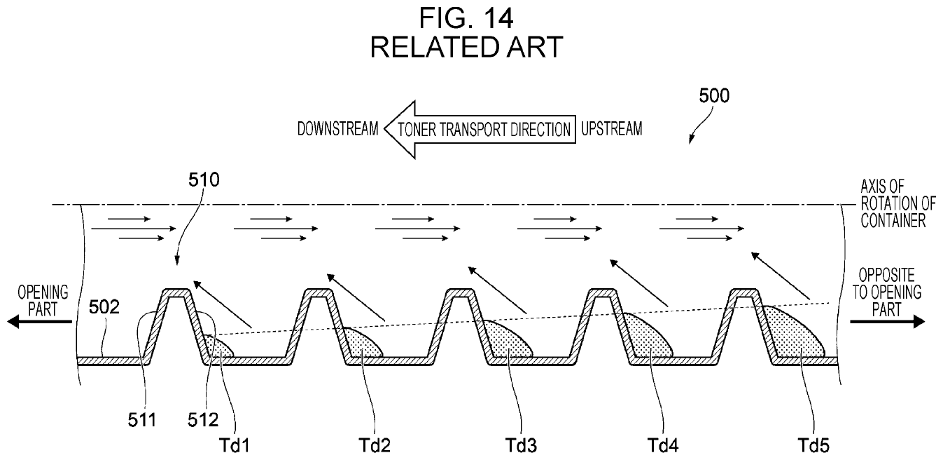

FIG. 14 illustrates a toner cartridge 500 of the related art. As illustrated in FIG. 14, the toner cartridge 500 has a spiral ridge 510 for transporting toner on an inner circumferential surface 502 thereof. The spiral ridge 510 is provided on the inner circumferential surface 502 such that protrusions thereof, as viewed in a cross-section of the spiral ridge 510, are spaced apart from each other. The spiral ridge 510 has a downstream-facing slope 511, which is a slope facing the side where an opening part is located, and an upstream-facing slope 512, which is a slope facing the side opposite to the opening part. In the toner cartridge 500 illustrated in FIG. 14, the angle formed between the downstream-facing slope 511 and the upstream-facing slope 512 is uniform across any cross-section of the spiral ridge 510.

Typically, when toner is transported in the toner cartridge 500 having the spiral ridge 510, the toner accumulates on the inner circumferential surface 502 of the toner cartridge 500. The toner that has accumulated on the inner circumferential surface 502 is removed in a recycling process, which will be described below. In the recycling process, the toner is removed by, for example, compressed air supplied from the opening part. At this time, the toner located farther away from the opening part is more difficult to remove. Hence, the toner Td1 to Td5 is likely to remain on the upstream-facing slope 512. In the exemplary embodiments of the present disclosure, the shape of the spiral ridge 510 is modified to reduce the residual toner.

### First Exemplary Embodiment

### Image Forming Apparatus

The exemplary embodiments of the present disclosure will be described in detail with reference to the accompanying drawings.

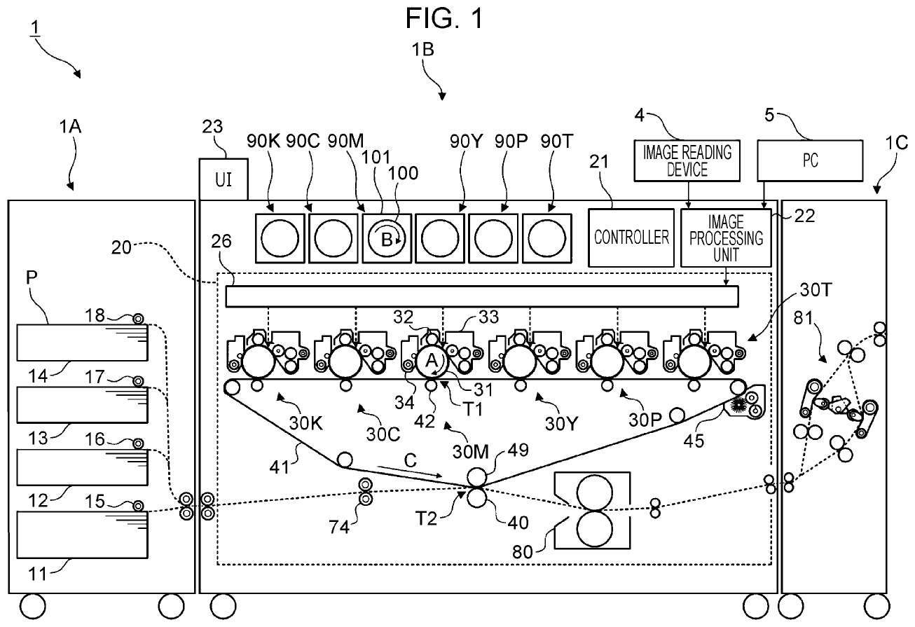

FIG. 1 illustrates an image forming apparatus 1 according to the exemplary embodiments of the present disclosure.

The image forming apparatus 1 includes a sheet feed unit 1A, an image forming unit 1B, and a sheet discharging unit 1C.

The sheet feed unit 1A includes first to fourth sheet containers 11 to 14 for storing sheets P, which are an example of recording materials.

The sheet feed unit 1A also includes feed rollers 15 to 18, provided corresponding to the first to fourth sheet containers 11 to 14, for feeding the sheets P stored in the sheet containers toward the image forming unit 1B.

The image forming unit 1B is a so-called tandem type image forming unit and includes an image-forming processing unit 20, which is an example of an image forming unit for forming an image on a sheet P. The image forming unit 1B also includes a controller 21 for controlling functional parts of the image forming apparatus 1.

The image forming unit 1B also includes an image processing unit 22 that performs image processing on image data transmitted from an image reading device 4 or a personal computer 5. The image forming unit 1B also includes a user interface (UI) 23 having a display panel and the like. The user interface (UI) 23 displays information to users and receives instructions from users.

The image-forming processing unit 20 includes six image forming units 30T, 30P, 30Y, 30M, 30C, and 30K (hereinbelow, sometimes simply referred to as “image forming units 30”) that are arranged in parallel at regular intervals.

Furthermore, toner supply units 90T, 90P, 90Y, 90M, 90C, and 90K (hereinbelow, sometimes simply referred to as “toner supply units 90”) are provided corresponding to the six image forming units 30T, 30P, 30Y, 30M, 30C, and 30K, respectively, to supply toner, which is an example of powder, to the image forming units 30.

Each of the image forming units 30 includes: a photoconductor drum 31 on which an electrostatic latent image is formed while the photoconductor drum 31 is rotating in the direction of arrow A; a charging roller 32 for charging the surface of the photoconductor drum 31; a developing device 33 for developing the electrostatic latent image formed on the photoconductor drum 31; and a drum cleaner 34 for removing untransferred toner and other particles remaining on the surface of the photoconductor drum 31.

The image-forming processing unit 20 also includes a laser exposure device 26 that radiates laser beams onto the photoconductor drums 31 provided in the image forming units 30T, 30P, 30Y, 30M, 30C, and 30K by scanning.

The image forming units 30 have substantially the same structure except for the toner stored in the developing devices 33. The image forming units 30Y, 30M, 30C, and 30K form toner images of yellow (Y), magenta (M), cyan (C), and black (K).

The image forming units 30T and 30P form toner images of colors other than the basic colors. Specifically, the image forming units 30T and 30P form toner images by using toner containing metal powder and toner of a special color or the like.

The toner supply units 90 each include a toner cartridge 100. The toner cartridge 100 accommodates toner.

The toner supply units 90 each include a rotation mechanism 101, which has a motor (not illustrated) and rotates the toner cartridge 100 in the direction B.

The toner cartridges 100 provided in the toner supply units 90Y, 90M, 90C, and 90K accommodate yellow (Y), magenta (M), cyan (C), and black (K) toner, respectively. The toner cartridge 100 provided in the toner supply unit 90T accommodates toner containing metal powder. The toner cartridge 100 provided in the toner supply unit 90P accommodates toner of a special color or the like.

The image-forming processing unit 20 includes an intermediate transfer belt 41 to which color toner images formed on the photoconductor drums 31 of the image forming units 30 are transferred in a superimposed manner. The image-forming processing unit 20 also includes first transfer rollers 42 for sequentially transferring (first transfer) the color toner images formed by the image forming units 30 to the intermediate transfer belt 41 at first transfer parts T1.

The image-forming processing unit 20 also includes a second transfer roller 40 for transferring (second transfer) the superimposed toner image on the intermediate transfer belt 41 to a sheet P at a second transfer part T2, a belt cleaner 45 for removing untransferred toner and other particles remaining on the surface of the intermediate transfer belt 41, and a fixing device 80 for fixing, to the sheet P, the image second-transferred to the sheet P.

When the image forming apparatus 1 forms an image, first, image data input from the image reading device 4 or a PC 5 is input to the image processing unit 22, where predetermined image processing is performed on the image data. The image data is then supplied to the laser exposure device 26.

For example, in the image forming unit 30M for magenta (M), the charging roller 32 charges the surface of the photoconductor drum 31 to a predetermined potential. Then, the laser exposure device 26 radiates a laser beam modulated according to the image data obtained from the image processing unit 22 onto the surface of the photoconductor drum 31. As a result, an electrostatic latent image is formed on the photoconductor drum 31.

The electrostatic latent image is then developed by the developing device 33, and a magenta toner image is formed on the photoconductor drum 31.

Similarly, in the image forming units 30Y, 30C, and 30K, yellow, cyan, and black toner images are formed, respectively. In the image forming units 30T and 30P, toner images of special colors and the like are formed.

The color toner images formed in the image forming units 30 are sequentially electrostatically transferred (first transfer) to the intermediate transfer belt 41, running in the direction of arrow C in FIG. 1, by the first transfer rollers 42. Thus, a superimposed toner image is formed on the intermediate transfer belt 41.

The toner image on the intermediate transfer belt 41 is transported to the second transfer part T2, where the second transfer roller 40 and a backup roller 49 are provided, as the intermediate transfer belt 41 runs.

Registration rollers 74 feed a sheet P to the second transfer part T2 in accordance with the timing at which the superimposed toner image is transported to the second transfer part T2.

At the second transfer part T2, the superimposed toner image on the intermediate transfer belt 41 is electrostatically transferred (second transfer) to the sheet P by the action of a transfer electric field formed between the second transfer roller 40 and the backup roller 49.

The sheet P to which the superimposed toner image has been electrostatically transferred is transported to the fixing device 80.

The fixing device 80 applies heat and pressure to the sheet P to fix the toner image to the sheet P. Then, the sheet P to which the image has been fixed passes through a curl corrector 81 provided in the sheet discharging unit 1C and is transported to a discharged-sheet stacker (not illustrated).

### Toner Cartridge

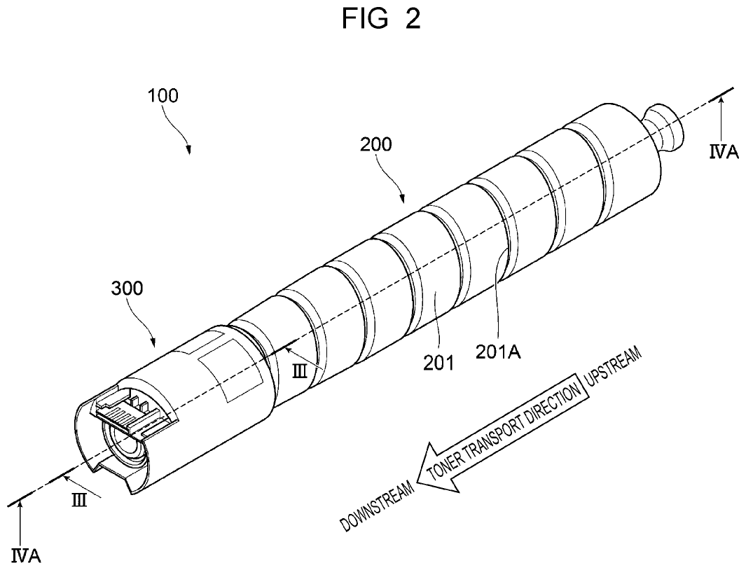

Next, the toner cartridges 100 according to the exemplary embodiments of the present disclosure will be described with reference to FIGS. 2 to 4. FIG. 2 is a perspective view illustrating the overall structure of a toner cartridge 100 as viewed from the rear side of the image forming apparatus 1 illustrated in FIG. 1. As illustrated in FIG. 2, the toner cartridge 100 provided in the toner supply unit 90, illustrated in FIG. 1, includes an opening part 300 through which toner is discharged to the outside of the toner cartridge 100. The toner cartridge 100 also includes a transport part 200 that is rotated in the direction B by the rotating mechanism 101, illustrated in FIG. 1, to transport the toner toward the opening part 300, which is provided downstream thereof in the toner transport direction. The transport part 200 is cylindrical and accommodates the toner. The transport part 200 has, in an outer circumferential surface 201 thereof, a groove 201A recessed into the transport part 200. The groove 201A has a spiral shape so as to be wound around the outer circumferential surface 201 of the transport part 200. The toner transport direction is a direction in which the toner is transported in the toner cartridge 100, which is from the upstream side to the downstream side. Furthermore, in the description below, the side where the opening part 300 is located is the downstream side in the toner transport direction, and the side opposite to the opening part 300 is the upstream side in the toner transport direction.

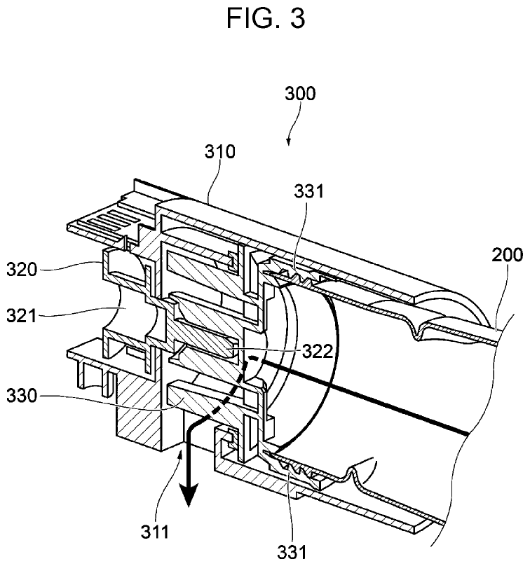

FIG. 3 is a cross-sectional view of the opening part 300, taken along line III-III in FIG. 2. As illustrated in FIG. 3, the opening part 300 includes a flange 310 to be fixed to the toner supply unit 90, a coupling 320 coupled to the rotation mechanism 101 illustrated in FIG. 1, and a cap 330 coupled to the coupling 320 to transmit the rotational driving force to the transport part 200. The flange 310 has an opening 311 through which the toner that has reached the opening part 300 is discharged to a transport mechanism (not illustrated). The transport mechanism transports the toner discharged therein to the corresponding image forming unit 30. The coupling 320 has a cylindrical hole 321 to be coupled to the rotation mechanism 101 illustrated in FIG. 1 and a cylindrical projection 322 to be coupled to the cap 330. The cap 330 has a corrugated surface 331 to be coupled to an end of the transport part 200. With this structure, the rotation of the rotation mechanism 101 in the direction B, illustrated in FIG. 1, is transmitted to the coupling 320, the cap 330, and the transport part 200 in this order, when the rotation mechanism 101 illustrated in FIG. 1 is coupled to the coupling 320. The flange 310, which is fixed to the toner supply unit 90, is not rotated by the rotation of the rotation mechanism 101 in the direction B, illustrated in FIG. 1.

Next, the transport part 200 will be described.

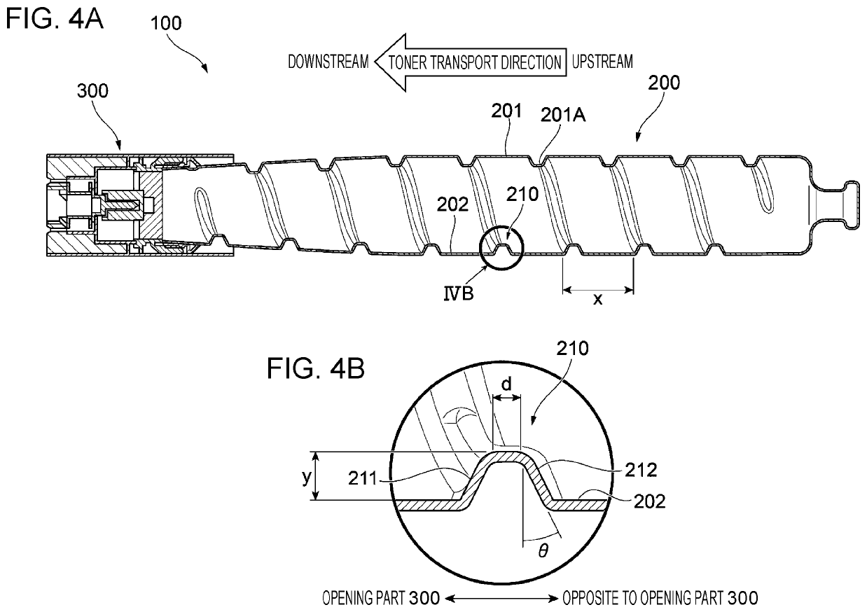

FIGS. 4A and 4B illustrate the structure of the transport part 200, in which FIG. 4A is a cross-sectional view taken along line IVA-IVA in FIG. 2. As illustrated in FIG. 4A, the transport part 200 has a spiral ridge 210 for transporting toner. The transport part 200 has the groove 201A in the outer circumferential surface 201, which forms the spiral ridge 210 on an inner circumferential surface 202 of the transport part 200. That is, the spiral ridge 210 is formed as a result of forming the spiral groove 201A. The spiral ridge 210 is formed on the inner circumferential surface 202 of the transport part 200 such that protrusions thereof, as viewed in a cross-section of the spiral ridge 210, are spaced apart by a constant distance x.

When the transport part 200 rotates in the direction B, as illustrated in FIG. 2, the spiral ridge 210 pushes the toner toward the rotation axis of the toner cartridge 100, thus moving the toner in the axial direction of the toner cartridge 100. In other words, when the transport part 200 rotates in the direction B, the spiral ridge 210 transports the toner so as to move the toner located upstream in the toner transport direction toward the opening part 300 located on the downstream side in the toner transport direction.

FIG. 4B is an enlarged view of the spiral ridge 210 in FIG. 4A, illustrating the spiral ridge 210 in more detail. As illustrated in FIG. 4B, the spiral ridge 210 includes a downstream-facing slope 211, which is a slope facing the side where the opening part 300 is located, and an upstream-facing slope 212, which is a slope facing the side opposite to the opening part 300, and an upper side d defined between the slopes 211 and 212. The spiral ridge 210 has a height y with respect to the inner circumferential surface 202 of the transport part 200. Thus, the downstream-facing slope 211 slopes down from one end of the upper side d of the spiral ridge 210 toward the inner circumferential surface 202 on the downstream side. The upstream-facing slope 212 slopes down from the other end of the upper side d of the spiral ridge 210 toward the inner circumferential surface 202 on the upstream side. The upstream-facing slope 212 is provided at an angle θ with respect to the normal to the upper side d. Note that the upstream-facing slope 212 of the spiral ridge 210 may be simply referred to as the slope 212 or the slope 212 of the spiral ridge 210. Furthermore, the angle θ of the slope 212 may be simply referred to as the angle θ.

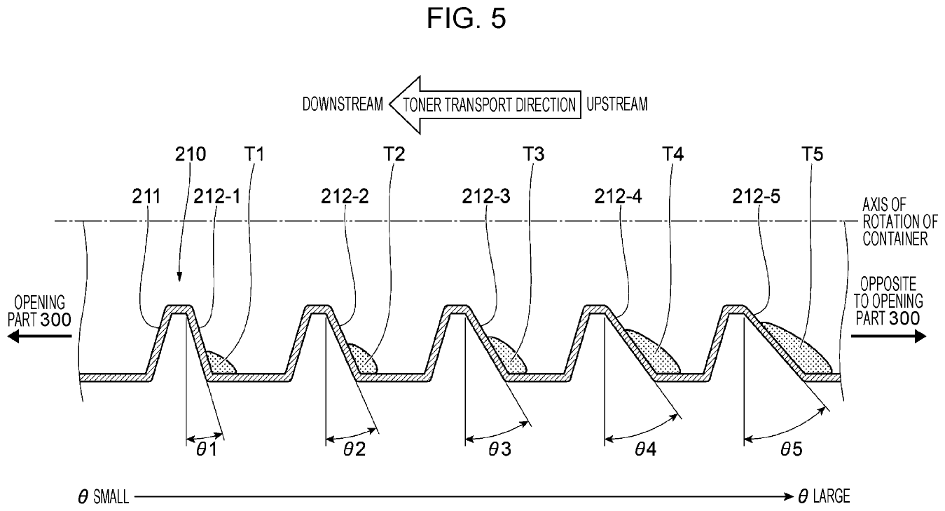

FIG. 5 illustrates the structure of the spiral ridge 210 according to the first exemplary embodiment. In the first exemplary embodiment, the slopes 212-1 to 212-5 of the protrusions of the spiral ridge 210 become less steep toward the side opposite to the opening part 300. In the example in FIG. 5, the angles θ1 to 05 of the slopes 212-1 to 212-5, as viewed in a cross-section of the spiral ridge 210, increase as: θ1<θ2<θ3<θ4<θ5.

In the first exemplary embodiment illustrated in FIG. 5, although the angles θ1 to 05 of the slopes 212-1 to 212-5 of the spiral ridge 210 gradually increase toward the side opposite to the opening part 300, the shapes and dimensions of the other portions stay the same. The slopes 212-1 to 212-5 of the protrusions of the spiral ridge 210 gradually become less steep toward the side opposite to the opening part 300, but the height of the spiral ridge 210 is constant. The angles θ1 to θ5 may be increased stepwise, rather than continuously. For example, in a two step structure, the angles θ1 to θ3 may be the same, and the angles θ4 and θ5 may be larger than the angles θ1 to θ3. A three step structure or other structures may also be adopted.

In the related art illustrated in FIG. 14, as described above, the toner that has accumulated on the inner circumferential surface 502 of the toner cartridge 500 is removed by compressed air supplied from the opening part 300. At this time, the toner located farther away from the opening part 300 is more difficult to remove. As a result, in the example in FIG. 14, the amount of residual toner Td1 to Td5 on the slope 512 increases from Td1 to Td5.

In contrast, in the first exemplary embodiment, as illustrated in FIG. 5, the upstream-facing slopes 212-1 to 212-5 gradually become less steep toward the side opposite to the opening part 300. In this structure, for example, the angle θ5 of the slope 212-5 is larger than the angle θ1 of the slope 212-1. Thus, the toner T5 on the slope 212-5 is easily blown out. Thus, the toner is effectively removed even if the force of the compressed air supplied from the opening part 300 decreases toward the side opposite to the opening part 300. As a result, the amount of residual toner T1 to T5 is smaller than the amount of residual toner Td1 to Td5 illustrated in FIG. 14.

### Second Exemplary Embodiment

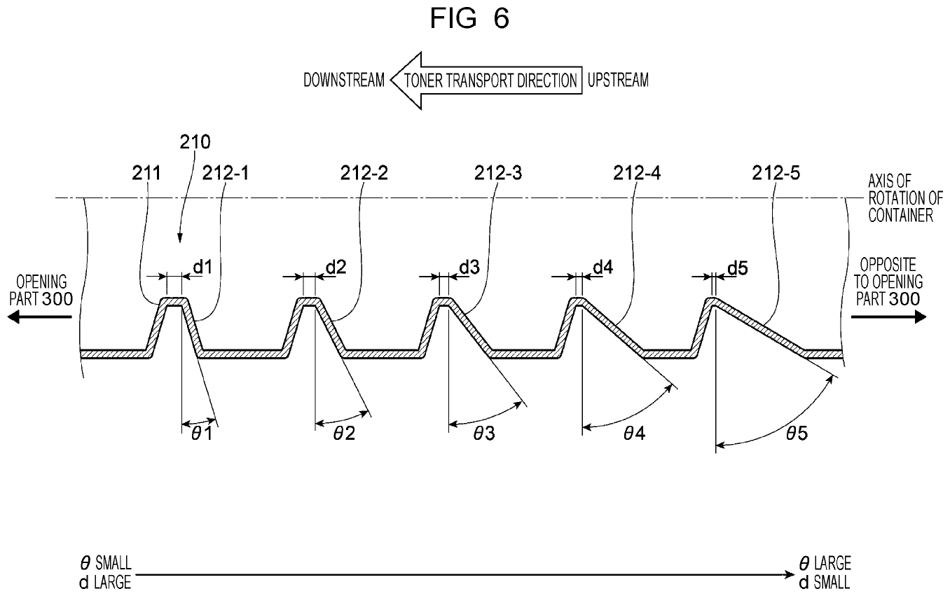

FIG. 6 illustrates the second exemplary embodiment. The second exemplary embodiment has the structure according to the first exemplary embodiment, in which the angles θ1 to θ5 of the slopes 212-1 to 212-5, as viewed in a cross-section of the spiral ridge 210, increase as follows: θ1<θ2<θ3<θ4<θ5. In addition, the second exemplary embodiment has a structure in which the lengths of the upper sides d1 to d5 of the protrusions of the spiral ridge 210 gradually decrease toward the side opposite to the opening part 300. In the example in FIG. 6, the lengths of the upper sides d1 to d5 have a relationship d5<d4<d3<d2<d1, and the upper side d5, which is most distant from the opening part 300, is shortest. Because the lengths of the upper sides d1 to d5 decrease toward the side opposite to the opening part 300, the flow of air is improved. Thus, although the force of the compressed air supplied from the opening part 300 decreases toward the side opposite to the opening part 300, the toner is more easily blown out over the upper sides d1 to d5.

### Third Exemplary Embodiment

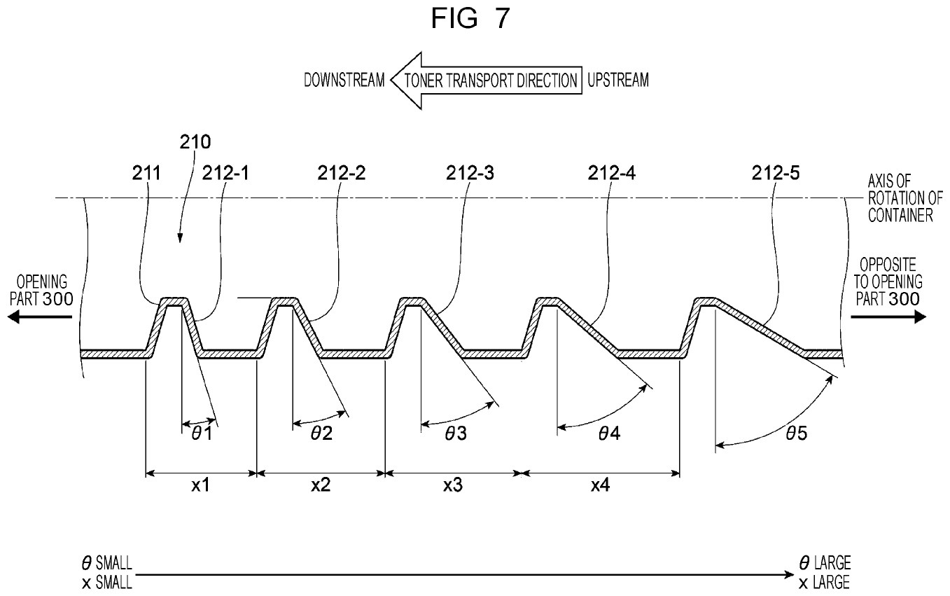

FIG. 7 illustrates the third exemplary embodiment. The third exemplary embodiment has the structure according to the first exemplary embodiment, in which the relationship θ1<θ2<θ3<θ4<θ5 is satisfied. In addition, the third exemplary embodiment has a structure in which the distances x1 to x4 between the protrusions of the spiral ridge 210 increase toward the side opposite to the opening part 300. In the example in FIG. 7, the distances x1 to x4 between the protrusions increase as follows: x1<x2<x3<x4. This reduces the number of protrusions, on which the toner is likely to accumulate, on the upstream side in the toner transport direction.

### Fourth Exemplary Embodiment

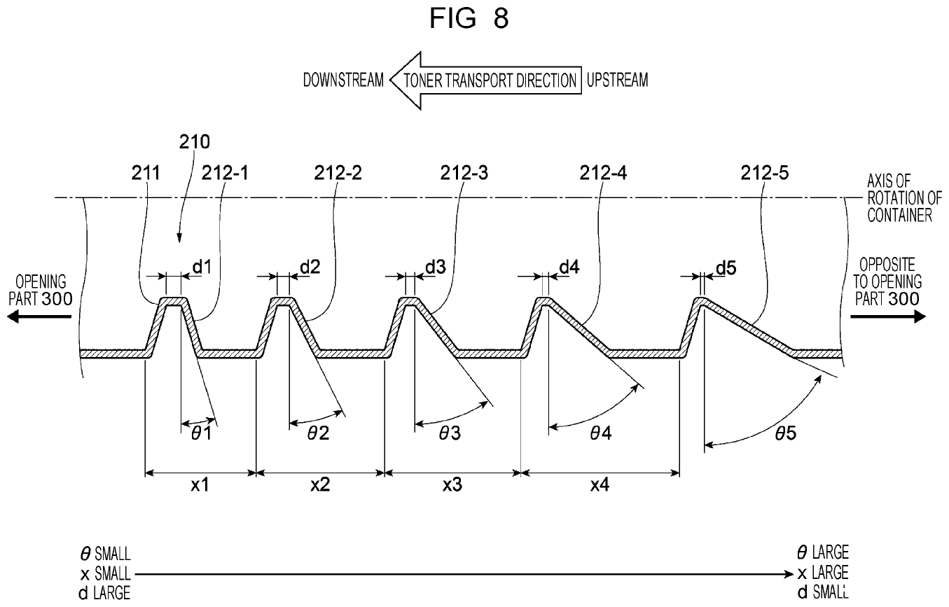

FIG. 8 illustrates the fourth exemplary embodiment. The fourth exemplary embodiment has the structure according to the second exemplary embodiment, in which the relationships θ1<θ2<θ3<θ4<θ5 and d5<d4<d3<d2<d1 are satisfied. In addition, the fourth exemplary embodiment has a structure in which the distances x1 to x4 between the protrusions of the spiral ridge 210 increase toward the side opposite to the opening part 300. In the example in FIG. 8, the distances x1 to x4 between the protrusions increase as follows: x1<x2<x3<x4. This reduces the number of protrusions, on which the toner is likely to accumulate, on the upstream side in the toner transport direction.

### Fifth Exemplary Embodiment

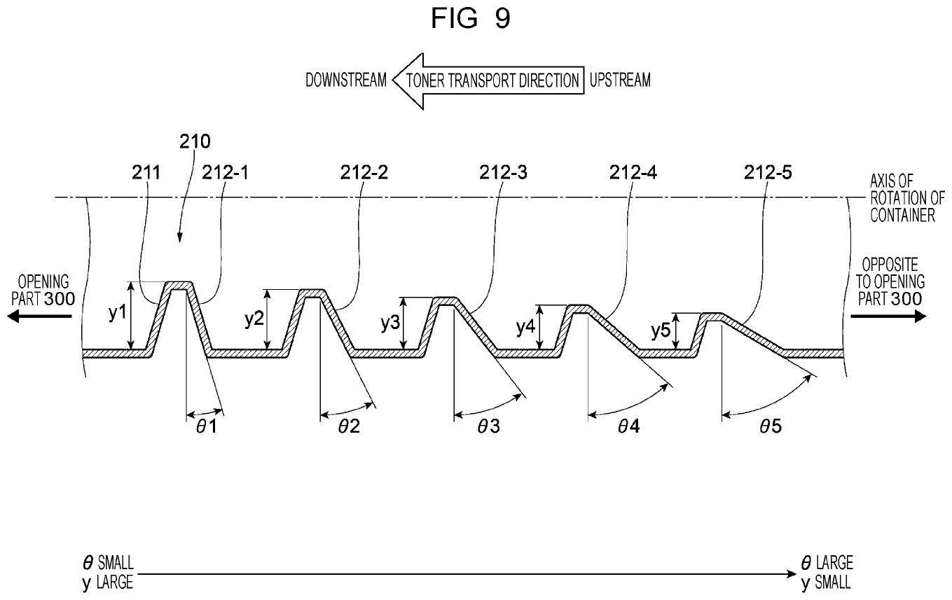

FIG. 9 illustrates the fifth exemplary embodiment. The fifth exemplary embodiment has the structure in the first exemplary embodiment, in which the relationship θ1<θ2<θ3<θ4<θ5 is satisfied. In addition, the fifth exemplary embodiment has a structure in which the heights y1 to y5 of the protrusions of the spiral ridge 210 gradually decrease toward the side opposite to the opening part 300. In the example in FIG. 9, the heights y1 to y5 have a relationship y5<y4<y3<y2<y1, and the height y5, which is most distant from the opening part 300, is lowest. This reduces the heights of the protrusions that block the flow of compressed air on the upstream side in the toner transport direction, where the force of the compressed air is weak.

### Sixth Exemplary Embodiment

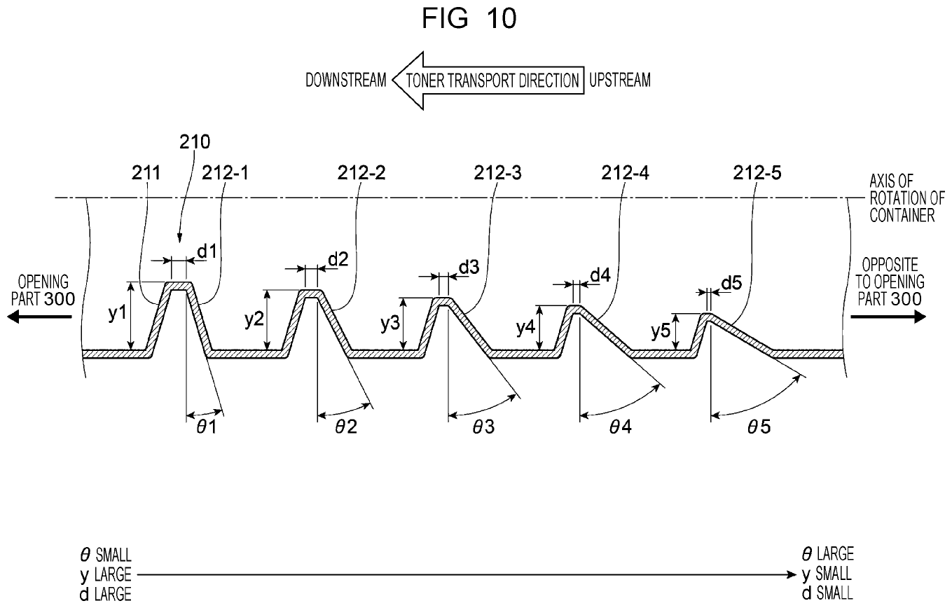

FIG. 10 illustrates the sixth exemplary embodiment. The sixth exemplary embodiment has the structure according to the fifth exemplary embodiment, in which the relationships θ1<θ2<θ3<θ4<θ5 and y5<y4<y3<y2<y1 are satisfied. In addition, the sixth exemplary embodiment has a structure in which the lengths of the upper sides d1 to d5 of the protrusions of the spiral ridge 210 gradually decrease toward the side opposite to the opening part 300. In the example in FIG. 10, the lengths of the upper sides d1 to d5 have a relationship d5<d4<d3<d2<d1, and the upper side d5, which is most distant from the opening part 300, is shortest. Because the lengths of the upper sides d1 to d5 decrease toward the side opposite to the opening part 300, the flow of air is improved. Thus, although the force of the compressed air supplied from the opening part 300 decreases toward the side opposite to the opening part 300, the toner is more easily blown out over the upper sides d1 to d5.

### Seventh Exemplary Embodiment

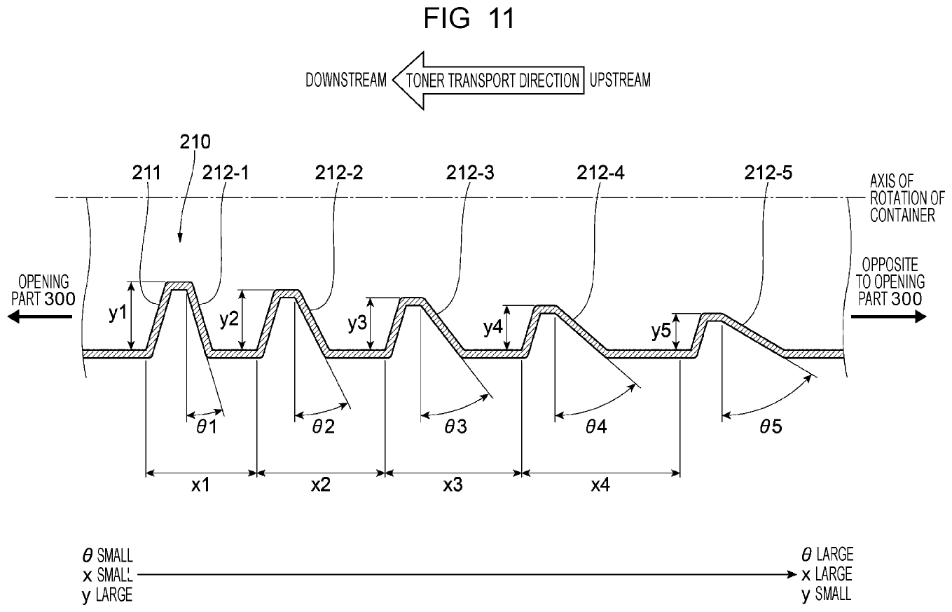

FIG. 11 illustrates the seventh exemplary embodiment. The seventh exemplary embodiment has the structure according to the fifth exemplary embodiment, in which the relationships θ1<θ2<θ3<θ4<θ5 and y5<y4<y3<y2<y1 are satisfied. In addition, the seventh exemplary embodiment has a structure in which the distances x1 to x4 between the protrusions of the spiral ridge 210 gradually increase toward the side opposite to the opening part 300. In the example in FIG. 11, the distances x1 to x4 between the protrusions increase as follows: x1<x2<x3<x4. This reduces the number of protrusions, on which the toner is likely to accumulate, on the upstream side in the toner transport direction.

### Eighth Exemplary Embodiment

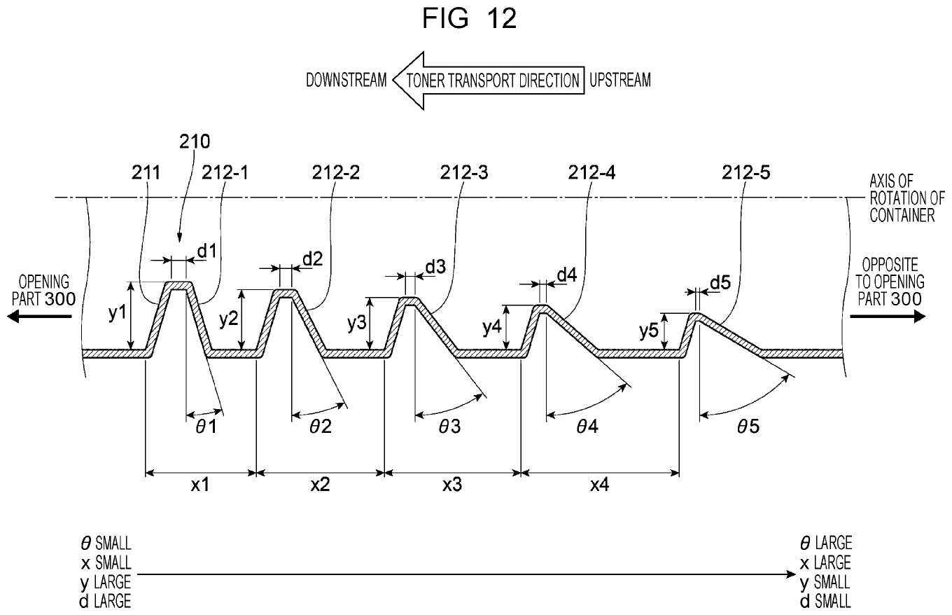

FIG. 12 illustrates the eighth exemplary embodiment. The eighth exemplary embodiment has the structure according to the sixth exemplary embodiment, in which the relationships θ1<θ2<θ3<θ4<θ5, y5<y4<y3<y2<y1, and d5<d4<d3<d2<d1 are satisfied. In addition, the eighth exemplary embodiment has a structure in which the distances x1 to x4 between the protrusions of the spiral ridge 210 gradually increase toward the side opposite to the opening part 300. In the example in FIG. 12, the distances x1 to x4 between the protrusions increase as follows: x1<x2<x3<x4. This reduces the number of protrusions, on which the toner is likely to accumulate, on the upstream side in the toner transport direction.

### Recycling Process

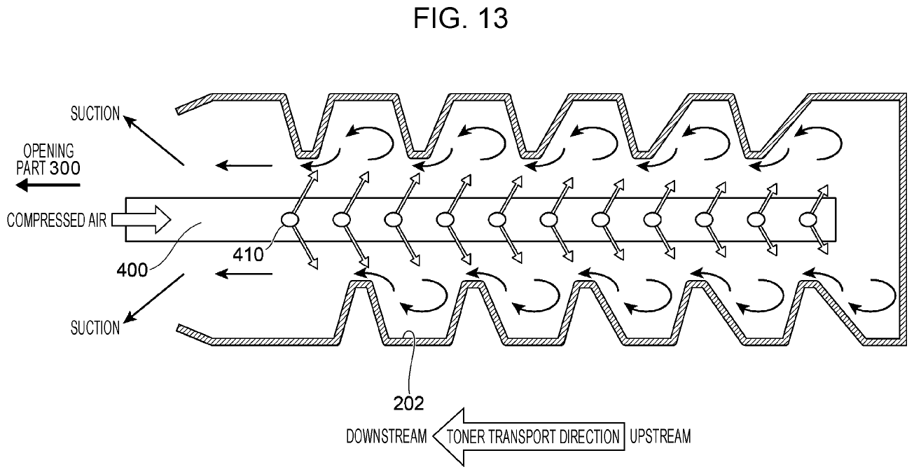

FIG. 13 illustrates the recycling process according to the exemplary embodiments of the present disclosure. In the recycling process, the toner that has accumulated on the inner circumferential surface 202 of the transport part 200 is collected by using a cleaning nozzle 400 or the like. As illustrated in FIG. 13, the cleaning nozzle 400 has blowing ports 410. The cleaning nozzle 400 blows, through the blowing ports 410, compressed air supplied from an air compressor (not illustrated). The compressed air blows off the toner on the inner circumferential surface 202 of the transport part 200. The toner blown off from the inner circumferential surface 202 moves toward the opening part 300, together with the compressed air. The compressed air and the toner that have moved to the opening part 300 are collected by an air suction device (not illustrated). The compressed air supplied to the cleaning nozzle 400 successively leaves the cleaning nozzle 400 through the discharge ports 410. Hence, the force of the compressed air to be discharged from the blowing ports 410 decreases toward the side opposite to the opening part 300. In contrast, in the exemplary embodiments of the present disclosure, as illustrated in FIGS. 5 to 12, by modifying the shape of the spiral ridge 210 (for example, by making the slope 212 gradually less steep toward the side opposite to the opening part 300), the toner is effectively removed even on the upstream side in the toner transport direction, where the force of the compressed air is weak.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A toner cartridge comprising: an opening part located on a downstream side in a toner transport direction; and a transport part configured to transport toner toward the opening part as the transport part rotates, the transport part having a spiral ridge formed on an inner surface thereof, the spiral ridge having an upstream facing slope facing an upstream side in the toner transport direction, the upstream facing slope becoming less steep toward the upstream side in the toner transport direction.

(((2)))

The toner cartridge according to (((1))), wherein the spiral ridge has a constant height, and the upstream-facing slope of the spiral ridge becomes less steep toward the upstream side in the toner transport direction.

(((3)))

The toner cartridge according to (((2))), wherein the spiral ridge further has a downstream-facing slope facing the downstream side in the toner transport direction, the upstream-facing slope and the downstream-facing slope define an upper side therebetween, and a length of the upper side decreases toward the upstream side in the toner transport direction, the length being a distance between the upstream-facing slope and the downstream-facing slope.

(((4)))

The toner cartridge according to (((2))) or (((3))), wherein a distance between protrusions of the spiral ridge increases toward the upstream side in the transport direction.

(((5)))

The toner cartridge according to any one of (((2))) to (((4))), wherein the height of the spiral ridge decreases toward the upstream side in the toner transport direction, and the upstream-facing slope becomes less steep toward the upstream side in the transport direction.

(((6)))

An image forming apparatus comprising: an image-forming processing unit including a developing device configured to develop an electrostatic latent image formed on a photoconductive member, a transfer unit configured to transfer the developed image to a sheet, and a heating unit configured to heat the sheet to which the developed image has been transferred; and a toner cartridge configured to supply toner to the developing device, the toner cartridge including an opening part located on a downstream side in a toner transport direction, and a transport part configured to transport toner toward the opening part as the transport part rotates, the transport part having a spiral ridge on an inner surface thereof, the spiral ridge having an upstream facing slope facing an upstream side in the toner transport direction, the upstream facing slope becoming less steep toward the upstream side in the toner transport direction.

What is claimed is:

1. A toner cartridge comprising:
an opening part located on a downstream side in a toner transport direction; and
a transport part configured to transport toner toward the opening part as the transport part rotates,
the transport part having a spiral ridge formed on an inner surface thereof,
the spiral ridge having an upstream facing slope facing an upstream side in the toner transport direction,
the upstream facing slope becoming less steep toward the upstream side in the toner transport direction.

2. The toner cartridge according to claim 1, wherein:
the spiral ridge has a constant height, and
the upstream-facing slope of the spiral ridge becomes less steep toward the upstream side in the toner transport direction.

3. The toner cartridge according to claim 2, wherein:
the spiral ridge further has a downstream-facing slope facing the downstream side in the toner transport direction,
the upstream-facing slope and the downstream-facing slope define an upper side therebetween, and
a length of the upper side decreases toward the upstream side in the toner transport direction, the length being a distance between the upstream-facing slope and the downstream-facing slope.

4. The toner cartridge according to claim 2, wherein a distance between protrusions of the spiral ridge increases toward the upstream side in the transport direction.

5. The toner cartridge according to claim 3, wherein a distance between protrusions of the spiral ridge increases toward the upstream side in the transport direction.

6. The toner cartridge according to claim 1, wherein:
the height of the spiral ridge decreases toward the upstream side in the toner transport direction, and
the upstream-facing slope becomes less steep toward the upstream side in the transport direction.

7. The toner cartridge according to claim 6, wherein:
the spiral ridge further has a downstream-facing slope facing the downstream side in the toner transport direction,
the upstream-facing slope and the downstream-facing slope define an upper side therebetween, and
a length of the upper side decreases toward the upstream side in the toner transport direction, the length being a distance between the upstream-facing slope and the downstream-facing slope.

8. The toner cartridge according to claim 6, wherein a distance between protrusions of the spiral ridge increases toward the upstream side in the transport direction.

9. The toner cartridge according to claim 7, wherein a distance between protrusions of the spiral ridge increases toward the upstream side in the transport direction.

10. An image forming apparatus comprising:
an image-forming processing unit including a developing device configured to develop an electrostatic latent image formed on a photoconductive member, a transfer unit configured to transfer the developed image to a sheet, and a heating unit configured to heat the sheet to which the developed image has been transferred; and
a toner cartridge configured to supply toner to the developing device, the toner cartridge including: an opening part located on a downstream side in a toner transport direction; and a transport part configured to transport toner toward the opening part as the transport part rotates, the transport part having a spiral ridge on an inner surface thereof, the spiral ridge having an upstream facing slope facing an upstream side in the toner transport direction, the upstream facing slope becoming less steep toward the upstream side in the toner transport direction.
